(19) United States
(12) Patent Application Publication
(10) Pub. No.: US 2007/0098353 A1
(43) Pub. Date: May 3, 2007

(54) DVD RECORDER WITH SURVEILLANCE FUNCTION

(75) Inventors: Ching-Hai Chen, Hsinchu (CN); Ching-Ho Huang, Hsinchu (CN)

Correspondence Address: MADSON & AUSTIN;GATEWAY TOWER WEST, SUITE 900, 15 WEST SOUTH TEMPLE, SALT LAKE CITY, UT, 84101, US

(73) Assignee: Lite-On it Corp., Taipei City (TW)

(21) Appl. No.: 11/551,415

(22) Filed: Oct. 20, 2006

(30) Foreign Application Priority Data
Nov. 1, 2005 (TW) 094138305
Nov. 9, 2005 (TW) 094139324

(51) Int. Cl. H04N 5/91

(52) U.S. Cl. 386/46

(57) ABSTRACT

A recording/reproducing apparatus with a surveillance function includes a first signal input terminal for receiving video signals from an image-capturing device; a second signal input terminal for receiving TV signals from a TV signal source; a control circuit coupled to the first and second signal input terminals for processing the video signals and/or the TV signals and executing a comparing procedure of the video signals, and when a first video signal and a second video signal sequentially received via the first signal input terminal have a difference greater than a threshold, converting the second video signal into a written data; and a storage device coupled to the control circuit for storing the written data.

### FIELD OF THE INVENTION

The present invention relates to a recording/reproducing apparatus, and more particularly to a recording/reproducing apparatus, such as a DVD recorder, with a surveillance function.

### BACKGROUND OF THE INVENTION

Please refer to FIG. 1, which is a functional block diagram illustrating a real-time DVD recorder 10. The DVD recorder can receive signals from various sources including a TV tuner 11, a video cassette recorder (VCR) player 12, a DVD player 13, and a digital video (DV) camera 14. Then, a control circuit 16 of the DVD recorder 10 processes the received signals into video data in a specific format, e.g. MPEG format, and has the resulting data written into a recordable/rewriteable optical disc 15 loaded into a disc burner 17 of the DVD recorder 10.

Referring to FIG. 2, a functional block diagram of another DVD recorder is shown. The DVD-recorder 100 comprises a disc burner 102, a control circuit 106 and a digital data storage device such as a hard disc drive 101. The signals received from the TV tuner 11, the VCR 12, the DVD player 13 or the DV camera 14 are firstly converted into digital data in a specified format such as MPEG by the control circuit 106. The MPEG digital data are then stored in the hard disc drive 101 in an editable manner. The edited digital data is then recorded into the recordable disc 15 by the disc burner 102. On the other hand, it is also possible to record the data previously stored in the disc 15 into the hard disc drive 101. For example, under the control of the control circuit 106, the signals from the TV tuner 11 are converted into the MPEG format video data, and stored in the hard disc drive 101 first. If necessary, the video data stored in the hard disc drive 101 is edited and then burned into the recordable/rewritable disc 15 by the disc burner 102. On the other hand, by directly converting the format of the digital video signals from the DV camera 14 into the specific format, the resulting video data can be stored into the hard disc drive 101, and optionally recorded into the optical disc 15 after being edited optionally.

Since the DVD recorder is capable of recording signals from a DV camera, the applications of the DVD recorder could be diversified, depending on the objects that the DV camera picks up.

### SUMMARY OF THE INVENTION

For example, the present invention provides a recording/reproducing apparatus with a surveillance function.

A recording/reproducing apparatus according to an embodiment of the present invention includes a first signal input terminal for receiving video signals from an image-capturing device; a second signal input terminal for receiving TV signals from a TV signal source; a control circuit coupled to the first and second signal input terminals for processing the video signals and/or the TV signals and executing a comparing procedure of the video signals, and when a first video signal and a second video signal sequentially received via the first signal input terminal have a difference greater than a threshold, converting the second video signal into a written data; and a storage device coupled to the control circuit for storing the written data.

In an embodiment, the first video signal and the second video signal are received by the control circuit at a first time point and a second time point, respectively, which are two consecutive sampling time points.

In an embodiment, following the conversion of the second video signal, the video signals received after the second time point are continuously converted into respective written data to be stored in the storage device until a difference between a third video signal and a fourth video signal sequentially received by the control circuit is determined below the threshold.

In an embodiment, the third video signal and the fourth video signal are received via the first signal input terminal at a third time point and a fourth time point, respectively, which are two consecutive sampling time points.

In an embodiment, before the fourth time point, there have been N consecutive video signals detected to have a difference from a preceding video signal lower than the threshold, where N is a preset integer.

In an embodiment, the control circuit processes the first video signal and the second video signal into a first image frame and a second image frame of a specific format, respectively. The difference between the first video signal and the second video signal is a sum of color-value differences between corresponding pixels of the first image frame and the second image frame. For example, the specific format is a MPEG format.

In an embodiment, the storage device is an optical disc burner for recording the written data into an optical disc.

In an embodiment, the recording of the written data is protected from interruption unless a security pin is entered by the user and verified by the control circuit.

In an embodiment, the storage device is a hard disc drive for storing the written data.

In an embodiment, the control circuit further includes a data buffer for temporarily storing the video signals captured by the image-capturing device, and at least one of the video signals stored in the data buffer is converted into a written data along with the second video signal when the difference is determined to be greater than the threshold.

In an embodiment, the recording/reproducing apparatus is a DVD recorder.

In accordance with another embodiment of the present invention, a recording/reproducing apparatus with a surveillance function includes a first signal input terminal for receiving video signals from an image-capturing device; a second signal input terminal for receiving TV signals from a TV signal source; and a control circuit coupled to the first and second signal input terminals for processing the video signals and/or the TV signals and executing a comparing procedure of the video signals, and when a first video signal and a second video signal sequentially received via the first signal input terminal have a difference greater than a threshold, showing the second video signal on a display.

In accordance with further embodiment of the present invention, a recording/reproducing apparatus with a surveillance function includes a first signal input terminal for receiving video signals from an image-capturing device; a second signal input terminal for receiving TV signals from a TV signal source; a storage device for storing the video signals as a video data file; and a control circuit coupled to the first and second signal input terminals and the storage device for processing the video signals into video data and executing a comparing procedure of the video signals, and when a first video signal and a second video signal sequentially received via the first signal input terminal have a difference greater than a threshold, inserting a start label into the video data file.

### BRIEF DESCRIPTION OF THE DRAWINGS

The above contents of the present invention will become more readily apparent to those ordinarily skilled in the art after reviewing the following detailed description and accompanying drawings, in which:

FIG. 1 is a functional block diagram illustrating a conventional real-time DVD recorder;

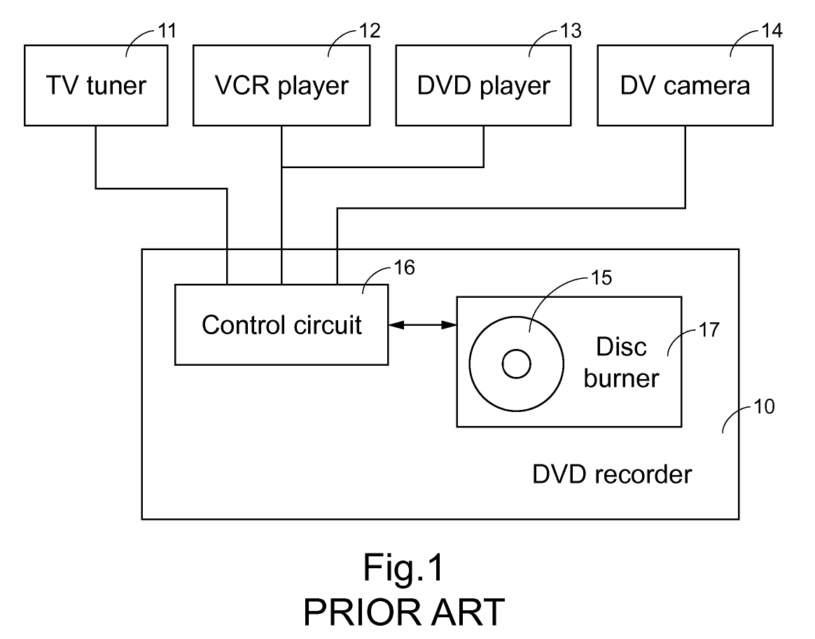

FIG. 2 is a functional block diagram illustrating another conventional DVD recorder;

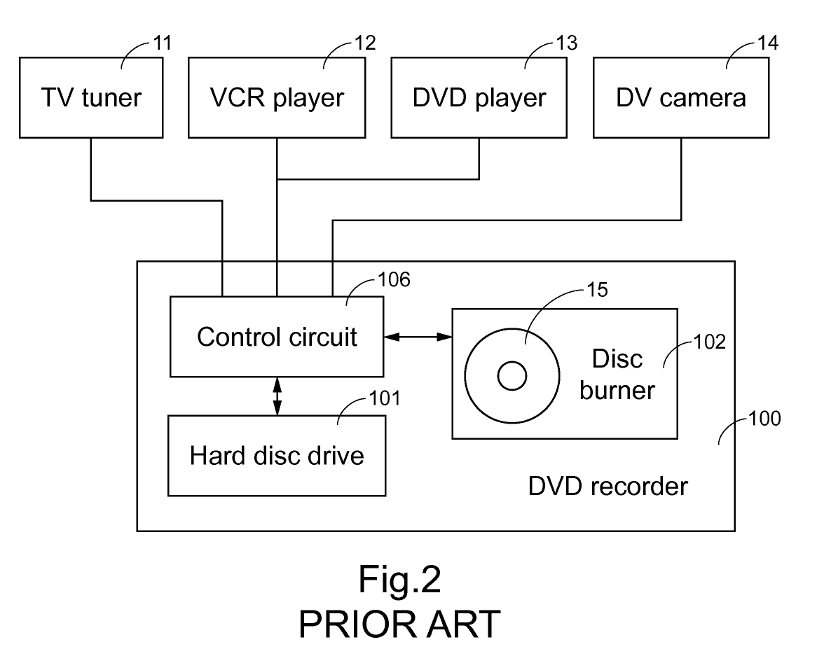

FIG. 3 is a functional block diagram illustrating a conventional digital video recorder surveillance system;

FIG. 4 is a functional block diagram illustrating a DVD recorder with a surveillance function according to an embodiment of the present invention; and

FIG. 5 is a functional block diagram illustrating a DVD recorder with a surveillance function according to another embodiment of the present invention.

### DETAILED DESCRIPTION OF THE PREFERRED EMBODIMENT

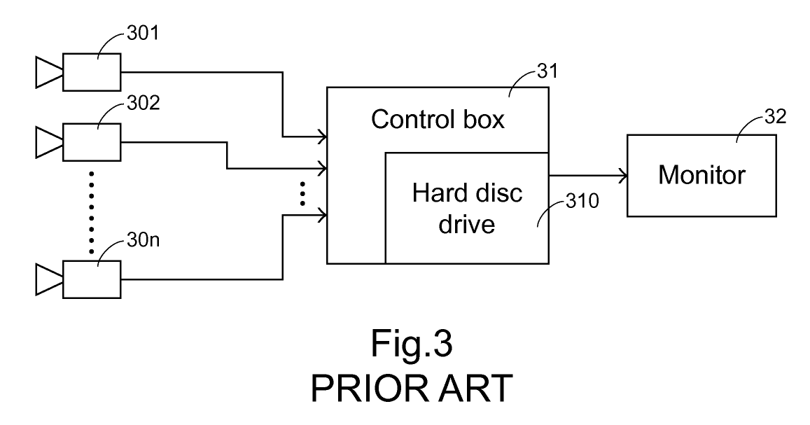

A recording/reproducing apparatus according to an embodiment of the present invention is able to perform a surveillance function. Various kinds of surveillance systems have been widely used for security. One of the examples is a digital video recorder surveillance system (DVRs). As shown in FIG. 3, the surveillance system includes a plurality of video cameras 301, 302 . . . 30n, a control box 31 and a monitor 32. The image signals captured by the cameras 301, 302 . . . 30n are transmitted to the control box 31 to be processed into an output image signal, which is displayed by the monitor 32. The surveillance system may further include a hard disc drive 301 in the control box 31 for saving the image signals. Since a recording/reproducing apparatus such as a DVD recorder is also able to cooperate with digital video cameras, the present inventors contemplated on the use of a recording/reproducing apparatus in a surveillance system.

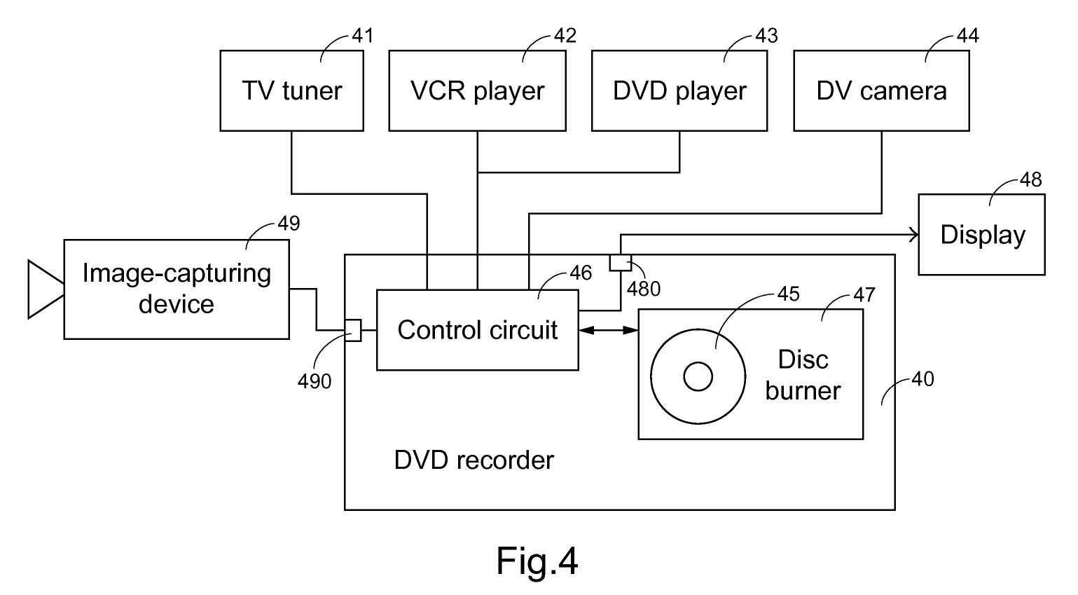

Please refer to FIG. 4. A recording/reproducing apparatus 40 according to an embodiment of the present invention, for example a real-time DVD recorder, further includes at least one signal input terminal 490 for performing a surveillance function in addition to its primitive functions. The signal input terminal 490, for example a BNC connector, receives video signals from one or more image-capturing device 49. The control circuit 46 processes signals received from respective signal input terminals coupled to various sources including a TV tuner 41, a VCR player 42, a DVD player 43, a DV 44 and the image-capturing device 49 into video signals of a specific format and selectively transfers the video signals of the specific format to a display 48 via a signal output terminal 480 and/or burns the video signals of the specific format into a recordable/rewritable disc 45. The specific format, for example, can be a MPEG format. In this way, the DVD recorder 40 can act as a part of a surveillance system with limited hardware expenses. In this embodiment, the signals captured by the image-capturing device 49 are transferred to the signal input terminal 490 via a cable. Alternatively, the signal transmission between the image-capturing device 49 and the signal input terminal 490 can be wireless. Besides, the signals captured by the image-capturing device 49 and transferred to the signal input terminal 490 can be either analog or digital, and then processed into a desired format by the control circuit 46.

For allowing the DVD recorder 40 to function as a part of a surveillance system while still being able to work normally, the control circuit 46 according to an embodiment of the present invention operates as follows.

The control circuit 46 continuously or periodically samples and compares the video signals received via the signal input terminal 490. If the video signals received at a first time point differ from those received at a second time point to a certain extent, it means unusual situations may happen in the place where the image-capturing device 49 is monitoring. Therefore, the control circuit 46 will start to receive and process the video signals from the image-capturing device 49 in to the specific format, and actuate a disc burner 47 of the DVD recorder 40 to record the video signals of the specific format into the recordable/rewritable disc 45. In this embodiment, respective color-value differences between pixels of the two image frames picked up at the first and second time points are summed. If the sum exceeds a threshold, the video signals captured by the image-capturing device 49 at the two time points, respectively, are determined to differ to the certain extent. Accordingly, the recording of the video signals captured by the image-capturing device 49 starts from the second time point. Meanwhile, the comparing procedure goes on with time. Once the difference between a pair of image frames drops below the threshold, which means no or little motion is detected, a counting action is triggered. If the count continuously accumulates up to a preset value, the recording of the video signals captured by the image-capturing device 49 suspends. In this way, an auto-recording function for surveillance purpose can be achieved.

In the above embodiment, the video signals captured by the image-capturing device 49 and showing unusual information are transmitted to the DVD recorder 40 to be saved in the disc 45 by the disc burner 47. In another embodiment, the video signals can also be transmitted to the DVD recorder 40 to be displayed in real time. If the DVD recorder 40 is working for other purposes when unusual situation occurs, the control circuit 46 will interrupt the work of the DVD recorder 46 to have the video signals shown on the display 48 or sound an alarm via a speaker (not shown) coupled to the display 48 or the DVD recorder 40. Like the previous embodiment, the work of the DVD recorder 40 automatically restores when the image frames do not change significantly for a period of time, i.e. the count accumulates up to the preset value. Alternatively, the interruption of the DVD recorder 40 can be stopped manually to restore the work of the DVD recorder 40.

In the previous embodiment, the video signals captured by the image-capturing device 49 are recorded only when unusual situation occurs. In this embodiment, the video signals captured by the image-capturing device 49 are continuously recorded by manually operating the DVD recorder 40, and yet the duration when unusual situation occurs is automatically marked. It is implemented by inserting a start label into the recorded file when the sum of the pixel differences exceeds the threshold, and inserting an end label when the under-threshold count as mentioned above accumulates up to the preset value. In this way, an independent chapter is created to direct to the suspicious image change so that the user can directly review the recorded video data by readily searching the chapter, for example by just clicking on the “NEXT” button.

In order to protect the recording procedure of the video signals from being unduly interrupted, a secure function is additionally imparted to the DVD recorder 40 in this embodiment. In other words, once the disc 45 starts to be burned, the burning procedure cannot be interrupted unless the interruption originates from the one who has the right to stop recording. For example, the user may input a security pin verified by the control circuit 46 to interrupt the recording procedure. The pin number can be preset and modifiable.

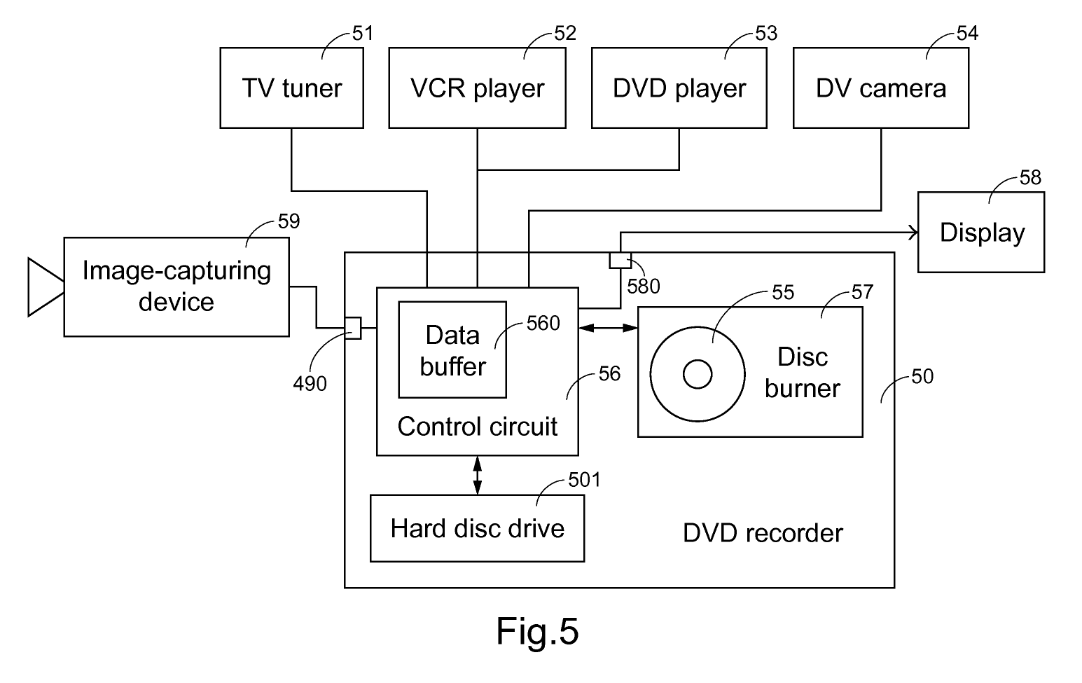

FIG. 5 illustrates a surveillance system including a real-time DVD recorder 50 according to another embodiment of the present invention. The DVD recorder 50 comprises a control circuit 56, a disc burner 57 and a hard disc drive 501 for recording data from a TV tuner 51; a VCR player 52, a DVD player 53, a DV 54 or one or more image-capturing devices 59 via respective signal input terminals. The video signals captured by the image capturing devices 59 are transmitted to the DVD recorder 50 via respective signal input terminal 590. Similar to the embodiment shown in FIG. 4, the control circuit 56 processes the received video signals into the desired format and has the video signals saved in a disc 55 or shown on a display 58 via a signal output terminal 580. Aside from, the received video signals can also be temporarily stored in a data buffer 560 of the control circuit 56 and then saved in the hard disc drive 501 or any other suitable storage device. It is understood that the video signals should be converted into written data of a format complying with the storage device by the control circuit 56.

The data buffer 560 has a fixed capacity for storing the video signals captured by the image-capturing device 59 before the video signals are transferred. The control circuit 56 continuously or periodically compares the video signals received via the signal input terminal 590. If the video signals received at a second time point differ from those received at a preceding first time point to a certain extent, it means unusual situations may happen in the place where the image-capturing device 59 is monitoring. Therefore, the control circuit 56 converts the video signals received from the second time point into written data of the format complying with the hard disc drive 501 to have the video signals of the specific format stored in the hard disc drive 501. Since the buffering of the data buffer 560 is provided, it is also feasible to store some video signals received prior to the second time point when the unusual situation really occurs. Therefore, more information can be realized.

The embodiments discussed with reference to the DVD recorder 40 can also be applied hereto. For example, respective color-value differences between pixels of the two image frames picked up at the first and second time points are summed. If the sum exceeds a threshold at the second time point, the video signals captured by the image-capturing device 59 start to be recorded from the second time point. Meanwhile, the comparing procedure goes on with time. Once the difference between a pair of image frames drops below the threshold, a counting action is triggered. If the count continuously accumulates up to a preset value, the recording procedure suspends. Furthermore, the work of the DVD recorder 50 can be interrupted by the significantly changing video signals so as to show the image captured by the image-capturing device 59 on the display 58 and/or sound a speaker of the display 58 or DVD recorder 50 to warn the user. Moreover, the recording procedure can be prolonged but divided into chapters for facilitating the searching task. It can be implemented by inserting start and end labels into the recorded file. The recording procedure can be prohibited from being arbitrary interrupted by presetting or setting a security pin.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A recording/reproducing apparatus with a surveillance function, comprising:
a first signal input terminal for receiving video signals from an image-capturing device;
a second signal input terminal for receiving TV signals from a TV signal source;
a control circuit coupled to the first and second signal input terminals for processing the video signals and/or the TV signals and executing a comparing procedure of the video signals, and when a first video signal and a second video signal sequentially received via the first signal input terminal have a difference greater than a threshold, converting the second video signal into a written data; and
a storage device coupled to the control circuit for storing the written data.

2. The recording/reproducing apparatus according to claim 1 wherein the first video signal and the second video signal are received by the control circuit at a first time point and a second time point, respectively, which are two consecutive sampling time points.

3. The recording/reproducing apparatus according to claim 2 wherein following the conversion of the second video signal, the video signals received after the second time point are continuously converted into respective written data to be stored in the storage device until a difference between a third video signal and a fourth video signal sequentially received by the control circuit is determined below the threshold.

4. The recording/reproducing apparatus according to claim 3 wherein the third video signal and the fourth video signal are received via the first signal input terminal at a third time point and a fourth time point, respectively, which are two consecutive sampling time points.

5. The recording/reproducing apparatus according to claim 4 wherein before the fourth time point, there have been N consecutive video signals detected to have a difference from a preceding video signal lower than the threshold, where N is a preset integer.

6. The recording/reproducing apparatus according to claim 1 wherein the control circuit processes the first video signal and the second video signal into a first image frame and a second image frame of a specific format, respectively.

7. The recording/reproducing apparatus according to claim 6 wherein the difference between the first video signal and the second video signal is a sum of color-value differences between corresponding pixels of the first image frame and the second image frame.

8. The recording/reproducing apparatus according to claim 6 wherein the specific format is a MPEG format.

9. The recording/reproducing apparatus according to claim 1 wherein the storage device is an optical disc burner for recording the written data into an optical disc.

10. The recording/reproducing apparatus according to claim 1 wherein the recording of the written data is protected from interruption unless a security pin is entered by the user and verified by the control circuit.

11. The recording/reproducing apparatus according to claim 1 wherein the storage device is a hard disc drive for storing the written data.

12. The recording/reproducing apparatus according to claim 1 wherein the control circuit further includes a data buffer for temporarily storing the video signals captured by the image-capturing device, and at least one of the video signals stored in the data buffer is converted into a written data along with the second video signal when the difference is determined to be greater than the threshold.

13. The recording/reproducing apparatus according to claim 1 being a DVD recorder.

14. A recording/reproducing apparatus with a surveillance function, comprising:
a first signal input terminal for receiving video signals from an image-capturing device;
a second signal input terminal for receiving TV signals from a TV signal source; and
a control circuit coupled to the first and second signal input terminals for processing the video signals and/or the TV signals and executing a comparing procedure of the video signals, and when a first video signal and a second video signal sequentially received via the first signal input terminal have a difference greater than a threshold, showing the second video signal on a display.

15. The recording/reproducing apparatus according to claim 14 wherein the control signal has a speaker sound as an alarm when the difference is greater than the threshold.

16. The recording/reproducing apparatus according to claim 14 wherein the first video signal and the second video signal are received by the control circuit at a first time point and a second time point, respectively, which are two consecutive sampling time points.

17. The recording/reproducing apparatus according to claim 16 wherein following the second video signal, the video signals received after the second time point are continuously shown on the display until a difference between a third video signal and a fourth video signal consecutively received by the control circuit is determined below the threshold.

18. The recording/reproducing apparatus according to claim 17 wherein before the fourth time point, there have been N consecutive video signals detected to have a difference from a preceding video signal lower than the threshold, where N is a preset integer.

19. A recording/reproducing apparatus with a surveillance function, comprising:
a first signal input terminal for receiving video signals from an image-capturing device;
a second signal input terminal for receiving TV signals from a TV signal source;
a storage device for storing the video signals as a video data file; and
a control circuit coupled to the first and second signal input terminals and the storage device for processing the video signals into video data and executing a comparing procedure of the video signals, and when a first video signal and a second video signal sequentially received via the first signal input terminal have a difference greater than a threshold, inserting a start label into the video data file.

20. The recording/reproducing apparatus according to claim 19 wherein the first video signal and the second video signal are received by the control circuit at a first time point and a second time point, respectively, which are two consecutive sampling time points.

21. The recording/reproducing apparatus according to claim 20 wherein the control circuit inserts an end label into the video data file when a difference between a third video signal and a fourth video signal consecutively received by the control circuit is determined below the threshold.

22. The recording/reproducing apparatus according to claim 21 wherein before the fourth time point, there have been N consecutive video signals detected to have a difference from a preceding video signal lower than the threshold, where N is a preset integer.

23. The recording/reproducing apparatus according to claim 19 wherein the storing of the video signals is protected from interruption unless a security pin is entered by the user and verified by the control circuit.
